(19) United States
(12) Patent Application Publication
(10) Pub. No.: US 2004/0060164 A1
(43) Pub. Date: Apr. 1, 2004

(54) High-performance substrate for magnetic isolator

(75) Inventors: Hong Wan, Plymouth, MN (US); Cheisan J. Yue, Roseville, MN (US)

Correspondence Address: Dennis C. Bremer, Honeywell International, Inc., 101 Columbia Road, P.O. Box 2245, Morristown, NJ, 07962-2245, US

(73) Assignee: Honeywell International Inc., Morristown, NJ (US)

(21) Appl. No.: 10/255,386

(22) Filed: Sep. 26, 2002

(51) Int. Cl. G11B 5/127; H04R 31/00

(52) U.S. Cl. 29/603.04; 29/603.07

(57) ABSTRACT

At high frequencies, signal losses may occur in circuit designs employing magnetic isolators. Eddy current losses in the magnetic isolator substrate material are at least partially responsible for this signal loss. As the Eddy current losses may depend on the properties of the substrate, the type of substrate chosen for fabricating a magnetic isolator may be critical for reducing these losses. By fabricating the magnetic isolator on a high performance substrate, the Eddy current losses are reduced and the magnetic isolator provides better output signals at high frequencies.

### FIELD

The present invention relates generally to substrates, and more particularly, relates to a high-performance substrate for use with magnetic isolators.

### BACKGROUND

Many electronic applications require some form of signal isolation. Signal isolation enables digital or analog signals to be transmitted without a galvanic connection between the transmitting and receiving side of the circuit. Signal isolation may prevent unwanted current and ground loops, damage to equipment, and injury to humans.

Opto-couplers and transformers are commonly used to provide signal isolation. Opto-couplers use light to couple two electrically isolated circuits. Opto-couplers may require custom package manufacturing, which may increase the cost of producing these devices. Additionally, while the use of opto-couplers for signal conditioning generally works well in digital signal isolation applications, the same does not hold true for analog signal isolation applications. Analog signals are typically isolated using transformers. However, transformers are bulky and ill suited for many circuit applications.

Due to problems encountered with these conventional signal isolation devices, the use of magnetic isolators in signal isolation applications has become more common. Magnetic isolators may be less expensive to manufacture than opto-couplers and consume less real estate than transformers. An example of a magnetic isolator can be found in commonly assigned U.S. Pat. No. 6,376,933, which is fully incorporated by reference. Magnetic isolators are typically formed on a bulk silicon substrate.

Unfortunately, in high frequency isolator applications, there may be a substantial signal loss due to substrate related Eddy currents. Eddy currents are electric currents produced inside a loop when the loop experiences a change in the magnetic flux through its surface or moves through a non-uniform magnetic field. Eddy current losses are energy losses due to eddy currents circulating in a resistive material.

Therefore, it would be beneficial to reduce the substrate related Eddy current losses in a magnetic isolator so that magnetic isolators may be used in high frequency isolator applications, especially those applications requiring operation in the gigahertz range. A high performance substrate may reduce the substrate related Eddy current losses in a magnetic isolator.

### BRIEF DESCRIPTION OF THE DRAWINGS

Presently preferred embodiments are described below in conjunction with the appended drawing figures, wherein like reference numerals refer to like elements in the various figures, and wherein:

FIG. 1 is a circuit diagram of a typical magnetic isolator, according to an exemplary embodiment;

FIG. 2 is a cross-sectional diagram of a typical magnetic isolator formed on a bulk silicon substrate; and

FIG. 3 is a cross-sectional diagram of a typical magnetic isolator formed on a high performance substrate, according to an exemplary embodiment.

### DETAILED DESCRIPTION

A high performance substrate may be used to reduce substrate related Eddy current losses in a magnetic isolator. While a typical magnetic isolator description is provided to describe the high performance substrate, this invention is not limited to any particular magnetic isolator design. It may be useful to describe the function of a typical magnetic isolator in order to describe how Eddy current losses occur and how the high performance substrate may be used to reduce these losses.

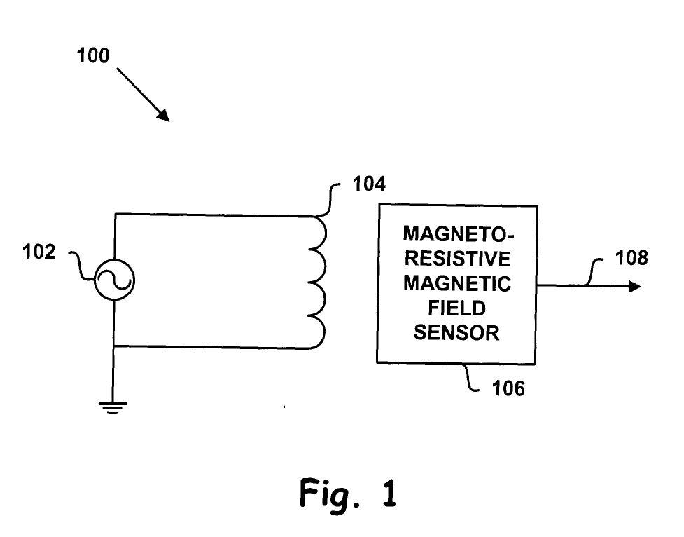

FIG. 1 is a circuit diagram of a typical magnetic isolator 100. The magnetic isolator 100 includes an input source signal 102, a coil 104, and a magneto-resistive magnetic field sensor 106. The input signal source 102 supplies an input signal to the coil 104, which generates an input magnetic field. The magneto-resistive magnetic field sensor 106 senses the input magnetic field and provides an output signal 108 that is proportional to the input signal.

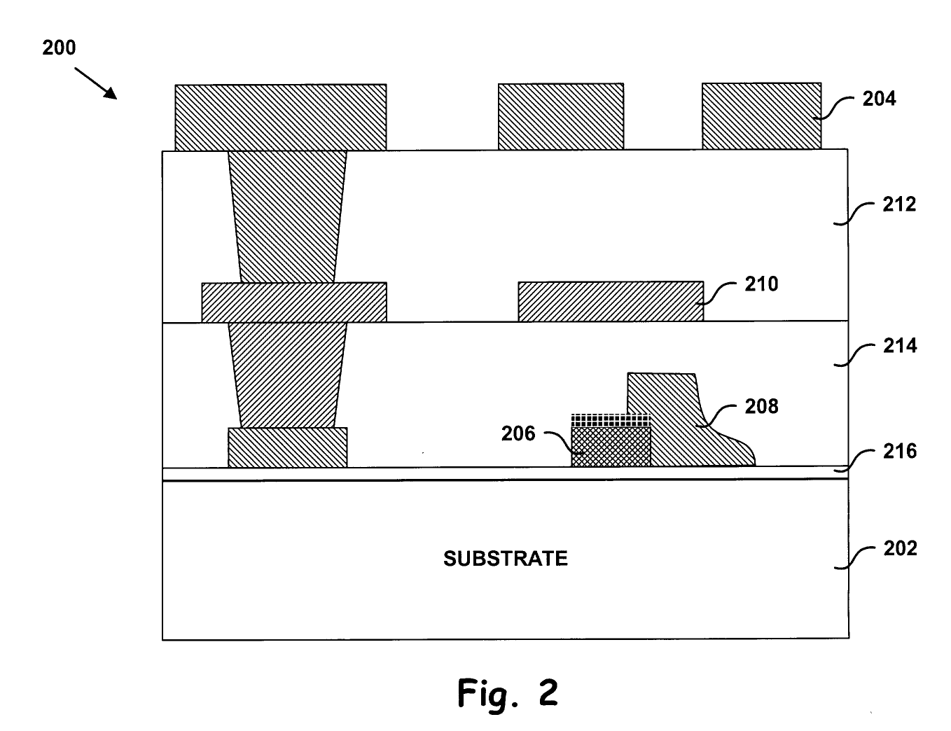

FIG. 2 is a cross sectional diagram of a typical magnetic isolator 200, similar to the one depicted in FIG. 1. The magnetic isolator 200 may be formed on a substrate layer 202. Typically the substrate layer 202 is a bulk silicon substrate material.

The magnetic isolator 200 includes a coil layer 204, a sensor layer 206, and a plurality of insulating layers. The coil layer 204 may substantially form the coil 104 as shown in FIG. 1. The sensor layer 206 may substantially form the magneto-resistive magnetic field sensor 106 as shown in FIG. 1. The magnetic isolator 200 may also include a first metal layer 208 and a second metal layer 210.

The coil layer 204 and the metal layers 208, 210 may be composed of a metal. For example, the layers 204, 208, 210 may be composed of aluminum, gold, copper, or tungsten. Other metals may also be used. The shape of the coil layer 204 may depend on coil configuration. For example, the coil 104 may be in a configuration determined by the number of turns, such as an eight-turn coil, or in a serpentine strip configuration.

The sensor layer 206 may include a plurality of layers. Some of the layers may be composed of ferromagnetic materials, while other layers may be composed of anti-ferromagnetic materials. The choice of layer materials and the ordering of the layers may depend on the type of magneto-resistive magnetic field sensor used in the magnetic isolator 200. For example, a giant magneto-resistive (GMR) sensor may include two magnetic layers separated by a non-magnetic conducting layer.

A first insulating layer 212 may be located substantially between the coil layer 204 and the second metal layer 210. A second insulating layer 214 may be located substantially between the second metal layer 210 and the sensor layer 206. A third insulating layer 216 may be located substantially between the sensor layer 206 and the substrate layer 202.

The insulating layers 212, 214, 216 may be composed of silicon nitride or other appropriate insulating material. The thickness of the first insulating layer 212 may determine the breakdown voltage of the magnetic isolator 200. Typically, a thicker first insulating layer 212 will result in a higher breakdown voltage of the magnetic isolator 200.

Eddy currents may develop in the coil layer 204 as the magnetic field in the coil 104 changes. Additionally, the Eddy currents may develop in the second metal layer 210. For example, if the second metal layer 210 is used for magnetic sensor condition or initialization the layer may be shaped in a coil configuration, which may allow Eddy currents to develop. The Eddy currents flow in a direction opposite to the direction of the magnetic field. The Eddy currents may cause substrate related Eddy current losses. The substrate related Eddy current losses reduce the magnitude of the magnetic fields generated by the coil 104, which results in signal loss.

The amount of Eddy current generated is inversely proportional to material resistivity. Therefore, the substrate material chosen for the substrate layer 202 may be critical for reducing Eddy current losses. For example, a substrate material with low conductivity may reduce the Eddy current losses and ultimately, reduce signal losses.

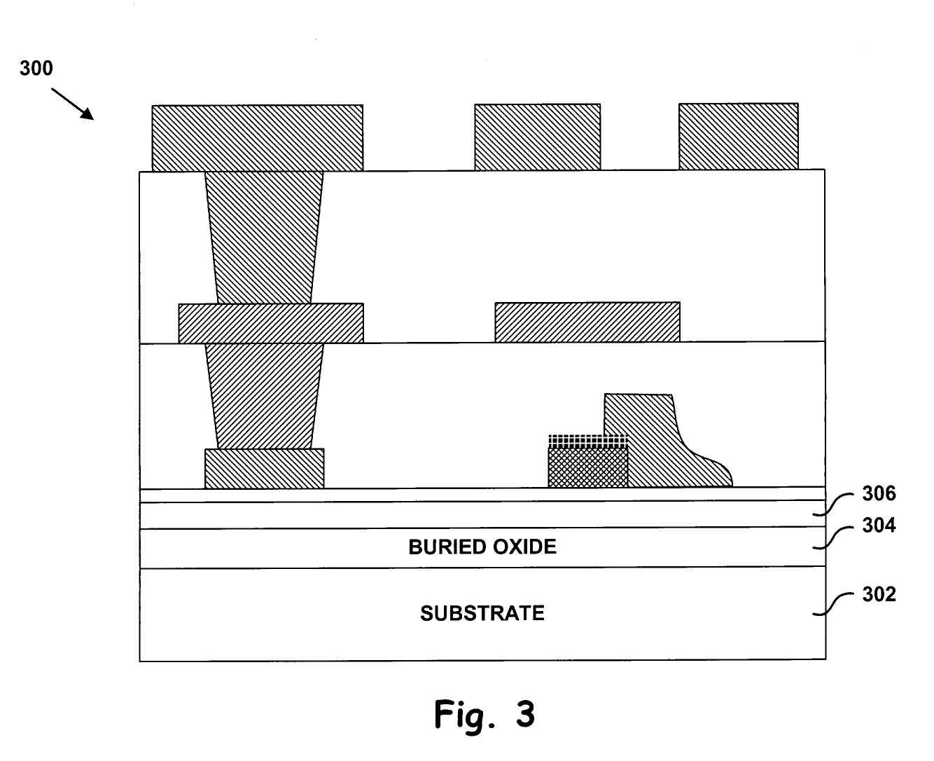

FIG. 3 shows the formation of a typical magnetic isolator 300 on a high performance substrate. In this example, a silicon-on-insulator (SOI) substrate is used; however, other semi-insulated or insulated substrates may also be used. The semi-insulated substrates may be a high-rho silicon substrate having a resistivity in the range of 1 K-ohm-cm or higher. The insulated substrates may be a substrate made with ceramic, glass, gallium arsenide (GaAs), or silicon carbon (SiC).

In this example, the magnetic isolator 300 is fabricated on an SOI substrate. An SOI substrate includes a buried oxide layer 304 over a silicon substrate layer 302. A top silicon layer 306 is located above the buried oxide layer 304. The buried oxide layer 304 may provide electrical insulation between the silicon substrate layer 302 and the top silicon layer 306. The remaining fabrication steps of the magnetic isolator 300 may be unchanged from the fabrication steps of the magnetic isolator 200.

By fabricating the magnetic isolator 300 on the SOI, the substrate 302 may be substantially isolated from the source of the Eddy currents, namely the coil 104. Alternatively, the use of the semi-insulated or insulated substrates may also substantially limit the Eddy currents from penetrating into the substrate layer 302. The substrate related Eddy current losses may be reduced, if not eliminated, by using the high performance substrate. The high performance substrate may be especially beneficial in high frequency magnetic isolator applications because Eddy current losses increase with frequency. In addition, by using a high performance substrate, power consumption of the magnetic isolator may be reduced.

It should be understood that the illustrated embodiments are exemplary only and should not be taken as limiting the scope of the present invention. The claims should not be read as limited to the described order or elements unless stated to that effect. Therefore, all embodiments that come within the scope and spirit of the following claims and equivalents thereto are claimed as the invention.

We claim:

1. A method of reducing substrate related Eddy current losses comprising fabricating a magnetic isolator on an insulated substrate.

2. The method of claim 1, wherein the insulated substrate is a substrate material selected from the group consisting of ceramic, glass, gallium arsenide, and silicon carbon.

3. A method of reducing substrate related Eddy current losses comprising fabricating a magnetic isolator on a silicon-on-insulator substrate.

4. A method of reducing substrate related Eddy current losses comprising fabricating a magnetic isolator on a semi-insulated substrate.

5. The method of claim 4, wherein the semi-insulated substrate has a resistivity substantially equal to 1 K-ohm-cm.

6. The method of claim 5, wherein the semi-insulated substrate has a resistivity greater than 1 K-ohm-cm.
